(19) United States
(12) Patent Application Publication
(10) Pub. No.: US 2009/0235871 A1
(43) Pub. Date: Sep. 24, 2009

(54) Animal towel and method

(76) Inventors: Judy Andreas, Fenton, MI (US); Susan Ellen Dorbeck, Brighton, MI (US)

Correspondence Address: ALEX RHODES;UNIT NO. 9, 50168 PONTIAC TRAIL, WIXOM, MI, 48393, US

(21) Appl. No.: 12/077,906

(22) Filed: Mar. 24, 2008

(51) Int. Cl. A01K 13/00; A01K 29/00; B68C 5/00

(52) U.S. Cl. 119/601; 119/600; 119/653; 54/79.1

(57) ABSTRACT

A low cost, effective towel and method for drying and removing dirt, mud, odors and parasites from a pet, such as dog or a cat, that has been exposed to water, dirt and mud from snow, rain, baths and swimming pools. The towel is comprised of a rectangular sheet of an absorbent material for covering the back and the sides of the animal, and apertures for threading the towel over the head and tail of an animal to cover the animal's back and sides. The towel may be either made of a sheet of non-woven disposable cellulose fibers or made of a re-usable sheet of woven cloth-like material or non-woven material capable of multiple uses.

### FIELD OF THE INVENTION

This invention relates to towels and more particularly to towels and methods for cleaning and drying cats, dogs and other small animals.

### BACKGROUND OF THE INVENTION

Although towels are old in the art, simple, low cost towels have not been developed for cleaning and drying small animals such as dogs and cats that have been exposed to mud, dirt, snow, rain, baths, lakes and swimming pools.

One problem with cleaning and drying small animals is that they absorb large amounts of dirt, mud and water that soil surrounding objects. Another problem is that animals instinctively shake themselves when they are dirty and wet, casting off large amounts of dirt, mud and water on surrounding objects. Immediate action is required to prevent them from soiling objects, such as clothes, cars and homes. Another problem is that wet animals exude strong and offensive odors. Another problem is that a marketable animal towel needs to be low in cost.

U.S. Pat. No. 6,170,438 is exemplary of the prior art. The patent discloses a complex bag-like bathrobe, used among other things for drying. The bathrobe is prepared from inner and outer layers of water absorbent and impervious materials. Edges of an inner layer of a thick water absorbent cloth are sewn together to form a bag-like structure. An outer layer of a water impervious material, like plastic or leather, is connected to the inner layer with a zipper.

### SUMMARY OF THE INVENTION

The present invention is a towel for cleaning and drying pets, such as cats and dogs. A primary object is to provide an effective, low cost towel for cleaning and drying animals. Another object, in addition to the foregoing object, is to provide an animal towel that is easy to use. Another object, in addition to the foregoing objects, is to prevent the soiling of clothes, homes and automobiles. With the foregoing objects in mind, one benefit of the invention is that can be quickly applied. Another benefit is that it is relatively low in cost. Another benefit is that it is easy to use.

In a preferred embodiment, the towel is disposable and is comprised of an absorbent rectangular sheet of a non-woven fibrous material that covers the top and sides of an animal. At opposite ends of the sheet are openings for threading the sheet over the head and tail of the animal. The openings may be apertures or sheared cuts in the sheet. In a second embodiment, the towel is re-usable and is made of a woven cloth-like material or a relatively thin blanket of a non-woven fibrous material that is capable of multiple uses. The second embodiment also includes openings for threading the sheet over the head and tail of the animal.

In employing the teachings of the present invention, a plurality of alternate constructions can be provided to achieve the desired results and capabilities. In this specification, only several embodiments are presented for the purpose of disclosing our invention. However, these embodiments are intended as examples only and should not be considered as limiting the scope of the invention.

The foregoing features, benefits, objects and best mode of practicing the invention and additional benefits and objects will become apparent from the ensuing detailed description of a preferred embodiment and the subject matter in which exclusive property rights are claimed is set forth in the numbered claims which are appended to the detailed description of the preferred embodiment.

### BRIEF DESCRIPTION OF THE DRAWINGS

FIG. 1 is a perspective view of a small dog and animal towel according to the present invention.

FIG. 2 is a plan view of the animal towel.

FIG. 3 is a front view of the animal towel.

FIG. 4 is a plan view of an alternate embodiment of the animal towel.

FIG. 5 is a left side view of a partially unraveled roll of animal towels.

FIG. 6 is a plan view of the partially unraveled roll of animal towels.

FIG. 7 is a plan view of a second embodiment of the animal towel.

FIG. 8 is a plan view of a third embodiment of the animal towel.

### DETAILED DESCRIPTION OF THE PREFERRED EMBODIMENT

Referring now to the drawings wherein like numerals designate like and corresponding parts throughout the several views, an animal towel is shown for cleaning and drying pets, such as cats and dogs after they have been exposed to water from snow, rain, baths, lakes and swimming pools. In a preferred embodiment, the towel is a disposable, easy to use towel made from a non-woven fibrous material. An important benefit is that it can be quickly applied. Another important benefit is that it is highly effective in preventing water, dirt and mud from soiling vehicles and homes. Still yet another benefit is that it is relatively low in cost.

The towel 20 is comprised of a highly absorbent rectangular sheet 21 for covering the top and sides of an animal 22. The length 34 and width 35 of the sheet 21 are preferably adequate to extend over the animal's back and sides. The rectangular sheet 21 is made from a virgin or re-cycled non-woven absorbent material such as cellulose fiber but may be made from a non-woven absorbent recycled cellulose or synthetic fiber. The outer surface of the sheet may be coated or laminated with a water impervious material.

In a second embodiment, the towel 20 is re-usable and the rectangular sheet 21 is made of a virgin or re-cycled cloth-like material, such as woven cotton fibers, terry cloth, chamois, or a relatively thin rectangular blanket of non-woven fibers, by way of example, Ahlstrom SPUNLACE™. In either embodiment, the towel 20 may be treated with flea and tick powder and/or various scents to kill or ward off parasites and to mask musty odors from wet fur.

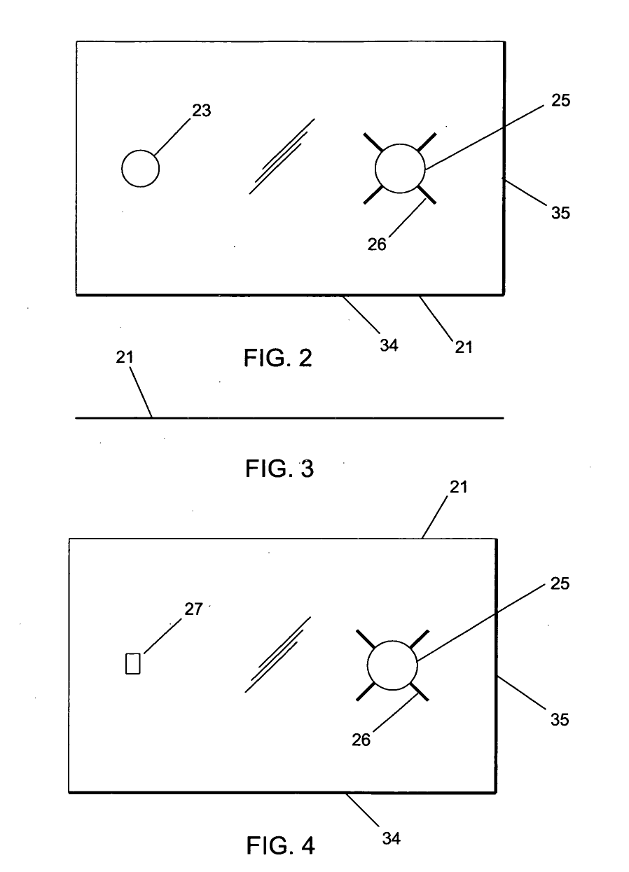

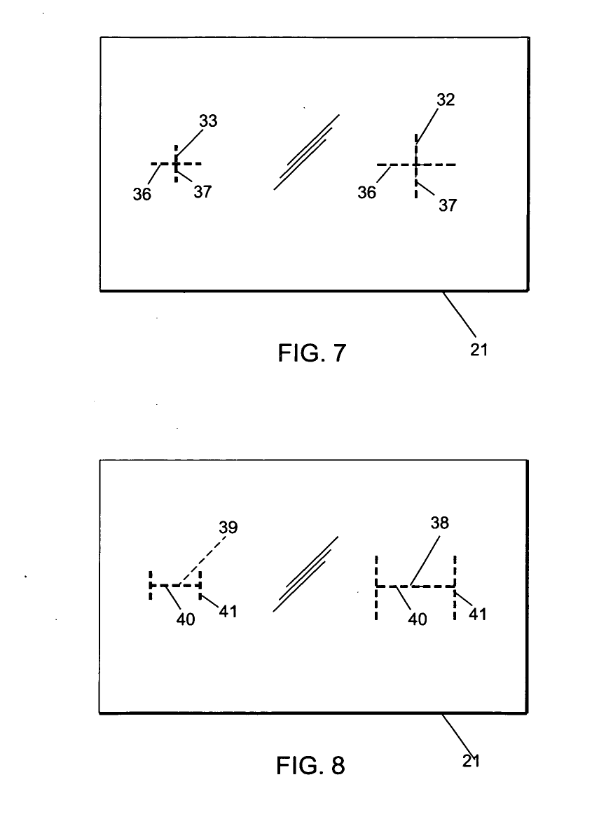

At one end of the towel 20 there is an aperture 25 for threading the towel 20 over an animal's head. As shown in FIG. 2, the outer portions of the aperture 25 may be sheared to provided outward extending radial cuts 26 to thread the towel 20 over various head sizes. At the opposite end of the towel 20 is an optional small aperture 23 for locating the towel 20 with respect to the animal's tail. In FIG. 4, an embodiment is shown wherein a small hook and loop fastener member 27 or an adhesive is used in place of the aperture 23. In FIGS. 7 and 8, embodiments are shown wherein the apertures 23, 25 of FIG. 2 are replaced with sheared cuts for threading the towel 21 over an animal's head and tail.

In FIG. 7, the sheared cuts 32, 33 are comprised of vertical cuts 37 and horizontal cuts 36 which intersect the mid points of the vertical cuts 37 at 90 degrees. In FIG. 8, the sheared cuts 38, 39 are comprised of horizontal cuts 40 having end points that intersect the mid points of the vertical cuts 37.

The towel 20 may be used in several ways. One preferred way is to immediately cover the animal's back and sides with the towel 20 by threading the towel 20 over the animal's head and wipe the animal back and forth with the towel 20 to absorb water and remove mud and dirt. Thereafter, threading the towel over the animal's tail and allowing the towel 20 to continue to dry the animal.

A second way is to first absorb water and remove dirt and mud by wiping or patting the animal with the towel 20. Thereafter, covering the animal's back and sides with the towel 20 by threading the towel 20 over the animal's head and tail and allowing the towel 20 to continue to dry the animal.

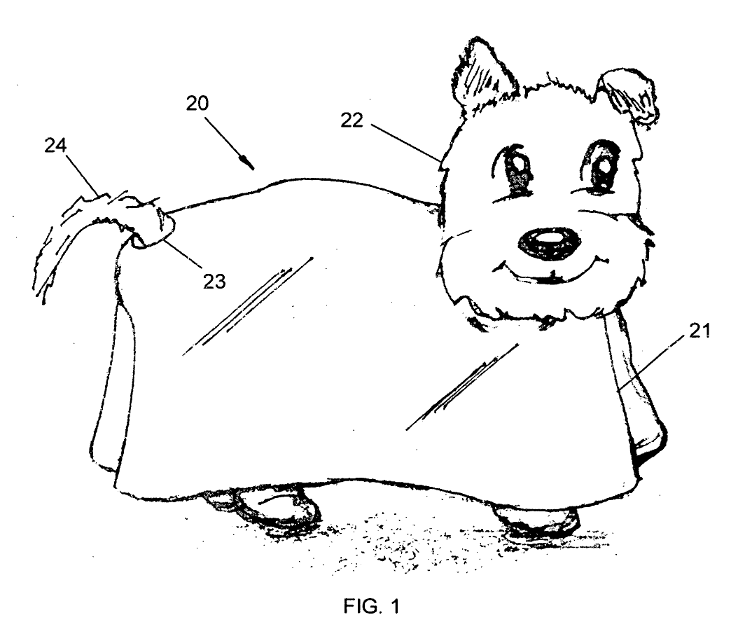

The present invention is intended to be sold in several sizes—small, medium, and large—for a range of animal sizes. With reference to FIG. 1, it is obvious that the towel 20 can be used as a poncho to protect an animal during inclement weather, such as rain and snow.

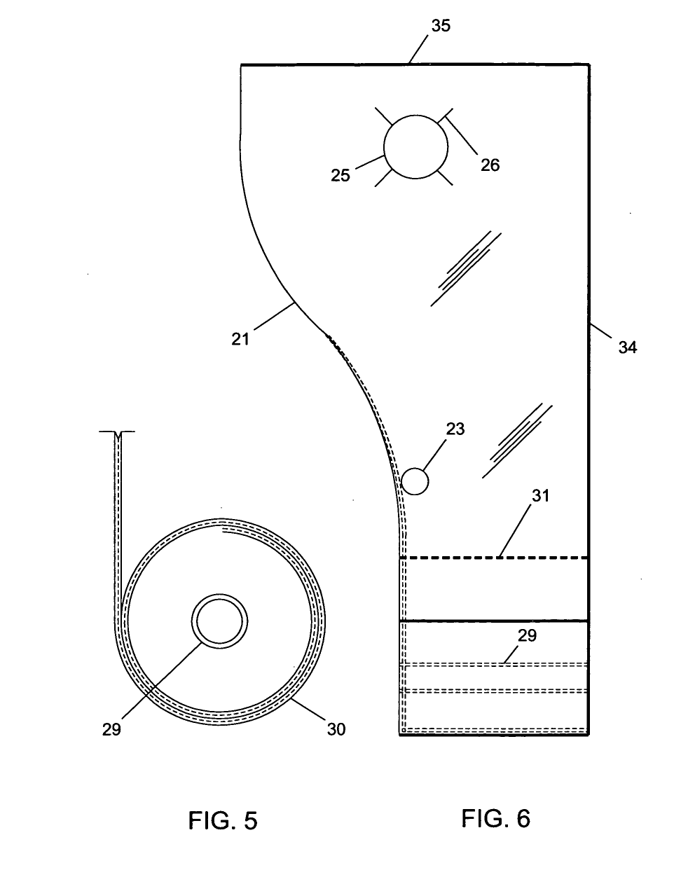

In FIGS. 5 and 6, we have shown a construction for marketing our invention. A roll of towels 30, separated by perforations 31 on a folded strip, are on a stiff cardboard tube 29. As shown in FIG. 6, towels 20 are separated from the strip by opening a folded portion of the strip and tearing the strip along a perforation 31 at an end of the roll 30. The towel 20 may also be marketed in separate folded units.

Although only several embodiments of our invention have been illustrated, it will be understood that other embodiments are possible by changes in material, shape and arrangement in parts without departing from the scope thereof.

What we claim is new is:

1. A towel for drying and removing dirt and mud from a small animal such as a household cat or dog, comprising a generally rectangular sheet of an absorbent material, said sheet having a length and a width which are adequate for covering a back and sides of the animal and an opening at one end of said sheet of material for threading said towel over a head of said animal to cover said back and said sides.

2. The towel recited in claim 1 further comprising a second opening in an opposite end of said sheet of material for further locating said towel on said animal by threading said towel over a tail of said animal when covering said back and said sides.

3. The towel recited in claim 1 further comprising outward extending cuts in outer edges of said opening for threading said towel over a range of animal head sizes.

4. The towel recited in claim 1 further comprising a small hook and loop fastener for locating said towel on said animal.

5. The towel recited in claim 1 further comprising a small adhesive patch for locating said towel on said animal.

6. The towel recited in claim 1 wherein said rectangular sheet is a sheet of absorbent non-woven cellulose paper.

7. The towel recited in claim 1 wherein said rectangular sheet is a re-usable sheet of an absorbent woven natural or synthetic cotton fiber.

8. The towel recited in claim 1 wherein said rectangular sheet is a re-usable sheet of absorbent terry cloth.

9. The towel recited in claim 1 wherein said rectangular sheet is a re-usable sheet of absorbent chamois.

10. A disposable towel for cleaning and drying a small animal such as a household cat or dog, comprising a generally rectangular sheet of a non-woven absorbent material, said sheet having a length and width which are sufficient for covering a back and sides of said animal and a group of cuts at one end of said rectangular sheet for threading said towel over a head of said animal to cover said back and said sides, said group of cuts being comprised of a longitudinal cut and at least one transverse cut.

11. The disposable towel recited in claim 10 wherein said sheet is treated with flea and tick powder to kill or ward off insects.

12. The towel for cleaning and drying a small animal as recited in claim 10 wherein said rectangular sheet is treated with various scents to mask off offensive odors.

13. A method for cleaning dirt and mud and drying animals such as dogs and cats that have been exposed to snow, rain, baths, lakes and swimming pools, said method comprised of the step of passing said animal's head through an aperture in a rectangular sheet of an absorbent material to cover said animal's back and sides with said rectangular sheet.

14. The method recited in claim 13 further comprising the step of threading said animal's tail through a second opening in said rectangular sheet of said absorbent material to cover said animal's back and sides with said rectangular sheet.

15. The method recited in claim 13 further comprising the step of allowing said drying to occur.

16. The method recited in claim 13 further comprising an initial step of separating said rectangular sheet from a roll of longitudinally folded material by tearing said folded material along a line of perforations.
